(19) United States
(12) Patent Application Publication
(10) Pub. No.: US 2003/0151878 A1
(43) Pub. Date: Aug. 14, 2003

(54) Electronic apparatus

(76) Inventors: Azuma Kano, Odawara (JP); Takuji Ogawa, Odawara (JP); Masahiko Sato, Odawara (JP); Satoshi Yagi, Oi (JP); Katsuyoshi Suzuki, Odawara (JP); Minoru Shimokawa, Odawara (JP); Kenichi Tateyama, Odawara (JP); Noboru Sakurai, Odawara (JP); Koichi Ono, Odawara (JP); Takuya Okaki, Oiso (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/358,893

(22) Filed: Feb. 6, 2003

(30) Foreign Application Priority Data
Feb. 8, 2002 (JP) 2002-031855

(51) Int. Cl. H02H 1/00

(52) U.S. Cl. 361/220

(57) ABSTRACT

An electronic apparatus includes an electronic device including electronic circuits, a first connector connected to the electronic circuit, and static electricity removal means, and a control device which includes a plurality of second connectors for connecting the electronic device and which is electrically connected to the static electricity removal means when the electronic device is being inserted and is electrically connected to the electronic device only via the first connector and the second connectors when the electronic device is mounted. Thus, it is possible to gradually discharge the static electricity when the electronic device is inserted into the control apparatus.

### BACKGROUND OF THE INVENTION

1. Field of the Invention

The present invention relates to an electronic apparatus capable of preventing devices from destruction and units from malfunction caused by discharging static electricity from an electronic device to be inserted into an electronic apparatus.

2. Description of the Related Art

A human body takes electric charge about 4×10⁴ volts as electrostatic charge. When a person wears clothing of chemical fiber, it takes more electric charge. In the case of inserting an electrostatic charged device into an electronic apparatus and of discharging or sparking at a contact between the electronic device and the apparatus during the insertion or after insertion completed, built-in electronic elements may be destroyed or caused malfunction.

According to Japanese Patent 2728747, a static electricity removal unit such as a static electricity removal brush is provided to slide along a cartridge containing an information recording medium and inserted into an information processing apparatus, so that the static electricity is discharged, thereby preventing the apparatus from the static electricity. Moreover, JP-A-6-349264 provides a static electricity removal unit not accompanied by electric discharge and fitted in a structure for inserting and ejecting a disc cartridge having accumulated static electricity into/from an external storage apparatus, thereby preventing the cartridge and apparatus from the static electricity.

However, unless an electric cut-off unit is provided, the electronic apparatus having electric circuit is damaged and electric elements of the electric circuit is destroyed, or a memory content is destroyed to cause malfunction by the static electricity attributed to external disturbance from outside of the electronic apparatus.

Moreover, when the static electricity removal unit is made from a material such as an extremely low electric resistance, the discharge is caused all at once and destroys a peripheral circuit depending on the resistance to voltage of the storage apparatus.

Thus, in the case of the electronic apparatus having a plurality of electronic devices detachably attached to the electronic apparatus and of inserting a charged electronic device into the electronic apparatus, the discharge or spark occurs via a connection portion between the electronic apparatus and the electronic device, which may destroy the electronic elements in another electronic device or cause malfunction.

### SUMMARY OF THE INVENTION

It is therefore an object of the present invention to provide an electronic apparatus capable of gradually discharging the static electricity when an electronic device is inserted into the electronic apparatus, thereby preventing the electronic device and an element in another electronic device from damage or malfunction and preventing the devices from electric damage by external disturbance from outside of the electronic device after mounted.

According to the electronic apparatus of the present invention, at a time of inserting a detachable electronic device into the electronic apparatus, the electronic device is grounded via the electronic apparatus by a static electricity removal unit made from a material having flexibility. When the insertion is complete, no electric connection is made between the electronic device and the electronic apparatus except for an electric connection unit.

Furthermore, the static electricity removal unit is made from a material having an electric resistance not smaller than 2.5×10⁵ Ω, and gradual discharge is enabled.

Moreover, the electronic device may be a storage unit in which a storage device such as a magnetic disc device and an optical disc device and electronic parts are built therein. In this case, the electronic apparatus has a plenty of storage units.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view showing an outline of an electronic apparatus according to the present invention.

FIG. 2 shows a connection portion between the electronic apparatus of the present invention and an electronic device.

FIG. 3 shows an outline of a magnetic disc unit according to the present invention.

FIG. 4 shows the magnetic disc unit of FIG. 3 mounted on a storage system apparatus.

FIG. 5 shows an outline of another example of the magnetic disc unit according to the present invention.

FIG. 6 shows the magnetic disc unit of FIG. 5 mounted on a storage system apparatus.

FIG. 7 is a perspective view of an insulation unit insulating a guide rail groove of the storage system apparatus on which the magnetic disc unit of FIG. 3 is mounted.

### DETAILED DESCRIPTION OF THE EMBODIMENTS

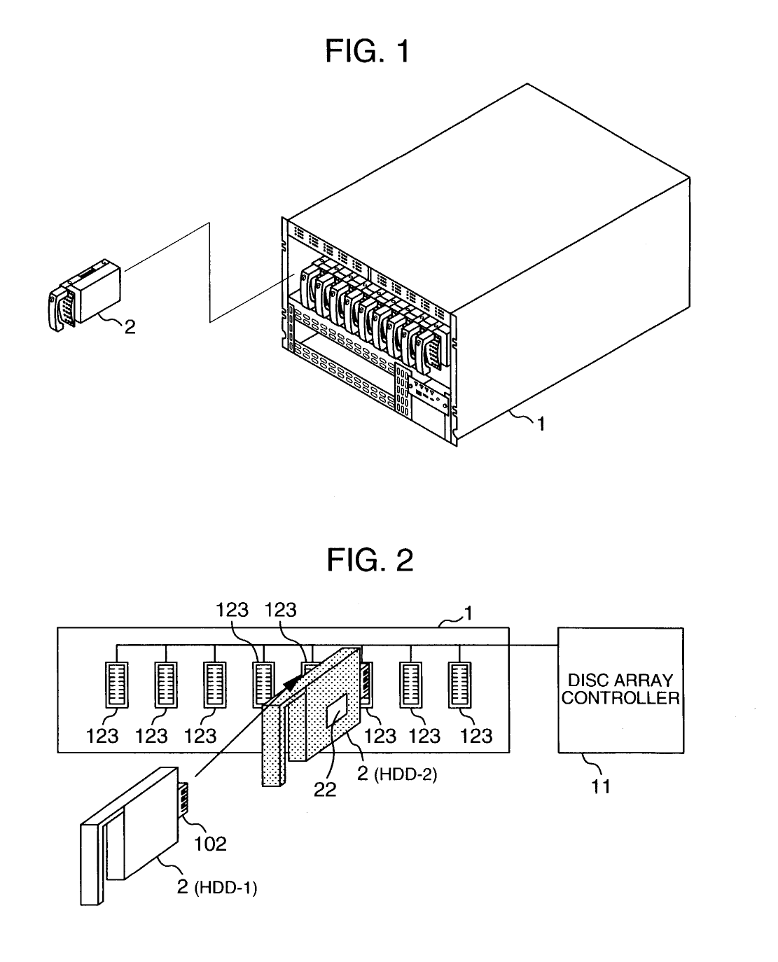

Description will now be directed to embodiments of the present invention with reference to FIG. 1 to FIG. 6.

FIG. 1 shows a storage system apparatus according to the present invention. The storage system apparatus 1 has a plurality of detachable magnetic disc units 2 having a built-in disc drive and electronic parts. Hereinafter, the magnetic disc unit will be referred to simply as a unit.

FIG. 2 shows a connection portion between the unit 2 (HDD-1, HDD-2) and the main body of the storage system apparatus 1. A plurality of connectors 123 are connected to a disc array controller 11 controlling the entire operation of the storage system apparatus 1. The storage apparatus system 1 and the unit 2 are connected to each other by the connector 123 and a connector 102 of the unit. The disc array controller 11 can control the disc drive in the unit 2.

Here, when the unit 2 is inserted into the storage system apparatus 1, if the unit 2 is charged by the static electricity, discharge or spark occurs via the connectors 102, 123, which may destroy the electronic parts of another unit or cause malfunction. That is, if the unit 2 (HDD-1) is charged when the unit 2 (HDD-1) is inserted thereinto, the static electricity is discharged when the connector 102 is connected to the connector 123 and the electricity flows into the unit 2 (HDD-2) connected by the connector 123 and the connector 102. Thus, there is a case that the content of a memory 22 which is an electronic part of the unit 2 (HDD-2) is destroyed by the discharge from the unit 2 (HDD-1) and trouble is caused in the operation of the unit 2 (HDD-2).

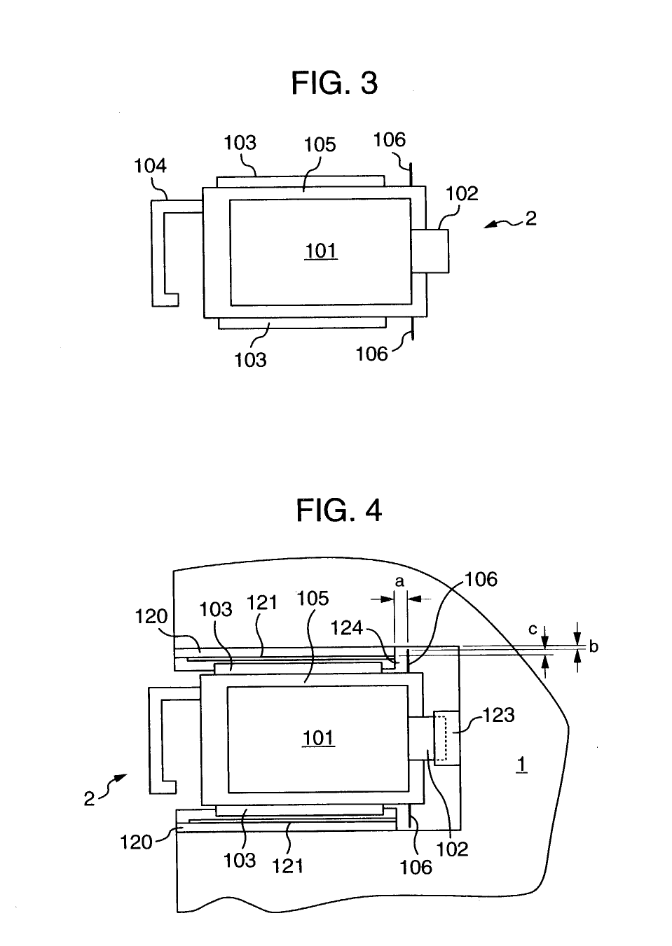

FIG. 3 shows the magnetic disc unit 2 according to the present invention. The unit 2 includes a main body 101 having a disc drive and electronic circuits, a connector 102 extending from the main body 101, a holder 105 holding the main body 101, a pair of opposing guide rails 103 for inserting the unit 2 into a correct position, a handle 104 for inserting and conveying the unit 2, and a static electricity removal brush 106 connected to the holder 105. The main body 101, the holder 105, and the electricity removal brush 106 are electrically connected to one another.

FIG. 4 is a longitudinal cross sectional view of the magnetic disc unit 2 of FIG. 3 inserted into the storage system apparatus 1. A pair of opposing guide rails grooves 120 including an insulation sheet 121 are arranged at the position corresponding to the upper and the lower guide rail 103. Moreover, the connector 123 is provided at a position corresponding to the connector 102, so that the unit 2 and the storage system apparatus 1 are electrically connected. When the unit 2 is charged by the static electricity, the discharge occurs via the connector 102 and the connector 123, adversely affecting another unit 2.

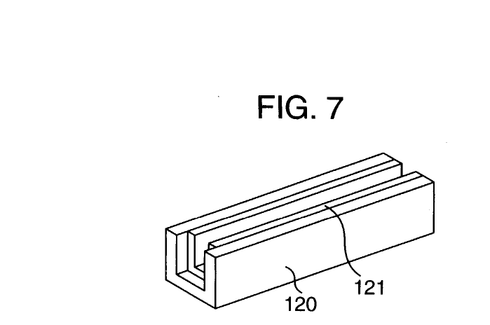

The guide rail groove 120 is electrically connected to the storage system apparatus 1 and is grounded. Here, when the guide rail 103 is made from an electrical insulation material such as synthetic resin, the insulation sheet 121 is not needed. When the guide rail 103 is made from an electrical conductor such as a metal, as shown in FIG. 7, in order to obtain electric insulation from the holder 105, the cross section of the insulation sheet 121 is made into U shape and built into the guide rail groove 120 using adhesive.

When the unit 2 is completely inserted into the storage system apparatus 1, the electricity removal brush 106 is at a distance “a” from the guide rail groove 120 and at a distance “b” from the storage system apparatus 1, thereby obtaining a sufficient space 124 for insulation of the electricity removal brush 106 and the storage system apparatus 1. Moreover, the electricity removal brush 106 has a length shorter by “c” than the interval between the electricity removal brush 106 and the guide rail groove 120. Accordingly, when inserting the unit 2 into the storage system apparatus 1, the electricity removal brush 106 can be surely brought into contact with the guide rail groove 120.

The human body is generally charged with static electricity. When a person wears clothing made of chemical fiber, the person may be charged to not smaller than 1×10⁶ volts. When the main body 101 is charged because of an artificial reason and the unit 2 containing the main body 101 is inserted into the storage system apparatus 1, firstly, the electricity removal brush 106 is brought into contact with the guide rail groove 120 to remove the static electricity. When the insertion is complete, a sufficient space 124 can be obtained and portions other than the connection portion between the connector 102 and the connector 123 are electrically insulated.

Consequently, it is possible to prevent logic control elements (not depicted) of the main body 101 from damage and malfunction of the information processing due to external disturbance accompanying the static electricity applied to the storage system apparatus 1 during and after the insertion.

Moreover, if the electricity removal brush 106 shown in FIG. 3 and FIG. 4 is made of a material having electric resistance not smaller than 2.5×10⁵ Ω, the discharge will not occur all at once when the electricity removal brush 106 is in contact with the guide rail groove 120 for discharge, and it is possible to prevent peripheral circuits from an abrupt discharge. The value of the electric resistance may be a value for handling the instantaneous discharge value which the disc drive in the unit 2 can stand. When the disc drive has a resistance to a large instantaneous discharge voltage, there is no problem if the electricity removal brush 106 has a resistance lower than the aforementioned value. Moreover, on the contrary, the resistance must be a value enabling the discharge before the disc drive is inserted completely. Actually, which of resistances the value is used depends on the resistance to voltage of the disc drive and the structure of the disc drive. It is preferable to select a material which satisfies the allowance in each case. The same applies to the electricity removal brush 106 shown in FIG. 6.

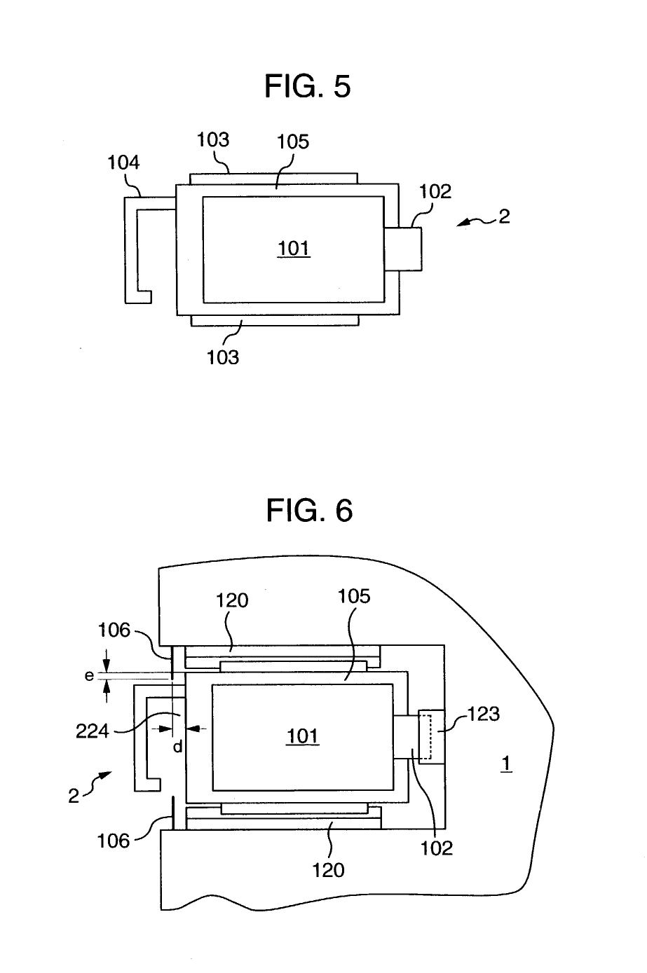

FIG. 5 shows the magnetic disc unit 2 according to another embodiment of the present invention.

The unit 2 of this embodiment includes a main body 101 having a disc drive and electronic parts, a connector 102 extending from the main body 101, a holder 105 for holding the main body 101, a pair of opposing guide rails 103 for inserting the unit 2 into a correct position, and a handle 104 for inserting and conveying the unit 2. The main body 101 and the holder 105 are electrically connected to each other.

FIG. 6 is a longitudinal cross section of the unit 2 of this embodiment inserted into the storage system apparatus 1. A pair of opposing guide rail grooves 120 are arranged at the position corresponding to the guide rail 103 above and below. The guide rail groove 120 is electrically insulated from the storage system apparatus 1. Moreover, the connector 123 is arranged at the position of the storage system apparatus 1 corresponding to the connector 102 for electrical connection between the unit 2 and the storage system apparatus 1. When the unit 2 is charged by the static electricity, the discharge or spark occurs via the connector 102 and the connector 123, adversely affecting another unit.

With the unit 2 mounted on the storage system apparatus 1, the electricity removal brush 106 has a space 224 of dimension “d” from the holder 105. Moreover, the electricity removal brush 106 has a length longer by “e” than the distance between the electricity removal brush 106 and the holder 105. Accordingly, when the unit 2 is inserted into the storage system apparatus 1, the electricity removal brush 106 can surely be in contact with the guide rail groove 120.

Since the human body is charged by the static electricity, the main body 101 is charged because of the artificial reason. When the main body 101 is inserted into the storage system apparatus 1, firstly, the electricity removal brush 106 is brought into contact with the holder 105 to remove the static electricity. When the insertion is complete, a sufficient space 224 is present and portions other than the connection portion between the connector 102 and the connector 123 are electrically insulated.

Accordingly, it is possible to prevent logic control elements (not depicted) built in the main body 101 from damage or malfunction of information processing due to external disturbance accompanying the static electricity applied to the storage system apparatus 1 during and after an insertion.

In the aforementioned embodiment, it is also possible to use an urging member such as a spring for stabilizing the unit 2 as the electricity removal brush 106. In this case, the same effect as the present invention can be obtained if the following configuration can be obtained. That is, when the unit 2 is inserted, the unit 2 is assured to be electrically connected to the storage system apparatus 1 via the urging member. When the unit 2 is then mounted on the storage system apparatus 1, the unit 2 and the storage system apparatus 1 are electrically insulated from each other.

Moreover, the electronic device inserted into the electronic apparatus to replace the storage system apparatus 1 is not limited to a magnetic disc unit. For example, the present invention should be applied to a device such as an additional frame connection device (device for connecting an additional frame body for adding an electronic device and an electronic apparatus via a connector to which the electronic device is connected). That is, a device which may discharge static electricity via the connector if the device is charged during insertion and may be affected, while mounted, by static electricity discharged during insertion of another device.

As has been described above, according to the present invention, when the detachable charged unit 2 is inserted into the storage system apparatus 1, the unit 2 or the storage system apparatus 1 has, for example, the electricity removal brush 106 having electric resistance not greater than 1×10⁶ Ω and it is possible to flow the static electricity energy to the ground through the storage system apparatus 1 at the initial stage of the insertion. Moreover, when the insertion of the unit 2 is complete, portions other than the connector 102 are not electrically connected to the storage system apparatus 1 and the unit 2 and a sufficient space can be obtained not in contact with the electricity removal brush 106.

Consequently, when inserting the unit 2 to be connected to the storage system apparatus 1 via the connector 102, it is possible to protect the unit 2 from adverse affect caused by discharge of the static electricity and prevent the built-in electronic elements from damage or malfunction. Furthermore, it is possible to prevent the electronic elements from the electric damage due to an external disturbance from outside of the unit 2 after mounted.

Moreover, by using the material having electric resistance, for example, not lower than 1×10⁵ Ω for the electricity removal brush, it is possible to prolong the discharge time during discharge, thereby preventing the circuits from damage due to an instantaneous discharge.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An electronic apparatus comprising:
an electronic device including an electronic circuit, a first connector connected to the electronic circuit, and static electricity removal means; and
a control device which includes a plurality of second connectors for connecting the electronic device and which is electrically connected to the static electricity removal means when the electronic device is being inserted and is electrically connected to the electronic device only via the first connector and the second connectors when the electronic device is mounted.

2. An electronic apparatus comprising:
an electronic device including a main body having an electronic circuit, a first connector connected to the main body, a holder for holding the first connector, a guide rail, and static electricity removal means; and
a control device which includes a plurality of second connectors for connecting the electronic device and a plurality of guide rail grooves for deciding the insertion position of the electronic device to oppose to the guide rail, wherein when the electronic device is being inserted, the static electricity removal means and the guide rail grooves are electrically connected and when the electronic device is mounted, the control device is electrically connected to the electronic device only via the first connector and the second connectors.

3. An electronic apparatus comprising:
an electronic device including an electronic circuit and a first connector connected to electronic circuit; and
a control device which includes a plurality of second connectors for connecting the electronic device and a plurality of static electricity removal means, wherein when the electronic device is being inserted, the control device is electrically connected to the static electricity removal means and when the electronic device is mounted, the control device is electrically connected to the electronic device only via the first connector and the second connectors.

4. An electronic apparatus comprising:
an electronic device including a main body having an electronic circuit, a first connector connected to the main body, a holder for holding the first connector, and a guide rail; and
a control device which includes a plurality of second connectors for connecting the electronic device, a plurality of static electricity removal means, and a plurality of guide rail grooves for deciding the insertion position of the electronic device to oppose to the guide rail, wherein when the electronic device is being inserted, the holder and the static electricity removal means are electrically connected and when the electronic device is mounted, the control device is electrically connected to the electronic device only via the first connector and the second connectors.

5. The electronic apparatus as claimed in claim 1, wherein the static electricity removal means is made of an elastic material and is grounded via a main body of the electronic apparatus.

6. The electronic apparatus as claimed in claim 1, wherein the static electricity removal means is made of a material having electric resistance not smaller than 2.5×10⁵ Ω.

7. The electronic apparatus as claimed in claim 1, wherein the electronic device is a magnetic disc unit having a magnetic disc device and the electronic apparatus is a storage system apparatus for controlling a plurality of magnetic disc devices to store information.

8. The electronic apparatus as claimed in claim 1, wherein the static electricity removal means is urging means for fixing the electronic device and the electronic apparatus when the electronic device is mounted on the electronic apparatus.

9. An electronic device including a main body having an electronic circuit, a connector connected to the main body, a holder for holding the connector, and static electricity removal means, wherein when the electronic device is inserted into another control device, the electronic device is electrically connected to the control device via the static electricity removal means.

10. An electronic apparatus including a plurality sets of a guide rail groove for inserting an electronic device, a second connector for connecting the electronic device, and static electricity removal means, and a control device operating in such a manner that the electronic device inserted is electrically connected to the static electricity removal means and when the electronic device is mounted, the electric connection is made only with the connector.
